(19) United States
(12) Patent Application Publication
(10) Pub. No.: US 2007/0252361 A1
(43) Pub. Date: Nov. 1, 2007

(54) Tow Assembly

(75) Inventor: Steven W. Houston, Evans, GA (US)

Correspondence Address: HARNESS, DICKEY & PIERCE, P.L.C., P.O. BOX 828, BLOOMFIELD HILLS, MI, 48303, US

(73) Assignee: Textron Inc., Providence, RI (US)

(21) Appl. No.: 11/381,029

(22) Filed: May 1, 2006

(51) Int. Cl. B60D 1/02

(52) U.S. Cl. 280/515

(57) ABSTRACT

A golf car is provided including a tow assembly having a hitch member. The hitch member can include first and second ends with a first mounting aperture at the first end and a second mounting aperture at the second end. The first and second mounting apertures can be generally aligned laterally with one another. The first mounting aperture can be rotatably coupled to a vehicle frame and the second mounting aperture can have an engagement portion selectively coupled to a towing member. The hitch member can further include a third mounting aperture laterally offset from the first and second mounting apertures. The third mounting aperture can be coupled to a steering link.

### FIELD

The present disclosure relates to golf cars and more specifically to tow assemblies for golf cars.

### BACKGROUND

The statements in this section merely provide background information related to the present disclosure and may not constitute prior art.

Golf cars provide transportation for golfers around a golf course. A golf car must also securely carry a golf bag in a location for convenient access throughout a round of golf. Many golf cars are equipped with tow assemblies that allow one golf car to tow another golf car. These tow assemblies can include tow bars and hitch members. The hitch members may be coupled to a steering link to allow the towing car to control steering of the towed car. However, if the steering link is bent and the attachment point between the steering link and the hitch member is in an over-center position, the golf car may be unable to turn.

### SUMMARY

According to the present disclosure, a golf car is provided including a tow assembly having a hitch member. The hitch member can include first and second ends with a first mounting aperture at the first end and a second mounting aperture at the second end. The first and second mounting apertures can be generally aligned laterally with one another. The first mounting aperture can be rotatably coupled to a vehicle frame and the second mounting aperture can have an engagement portion selectively coupled to a towing member. The hitch member can further include a third mounting aperture laterally offset from the first and second mounting apertures. The third mounting aperture can be coupled to a steering link.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a golf car including the tow assembly of the present teachings;

FIG. 2 is an additional perspective view of the golf car of FIG. 1;

FIG. 3 is an exploded view of a front portion of the golf car of FIG. 1;

FIG. 4 is a perspective view of the front portion of the golf car of FIG. 3 assembled;

FIG. 5 is an exploded view of a rear portion of the golf car of FIG. 1;

FIG. 6 is a perspective view of a tow bar latch base seen in FIG. 5;

FIG. 7 is a perspective view of a tow bar latch shown in FIG. 5;

FIG. 8 is a perspective view of a tow bar pivot shown in FIG. 5;

FIG. 9 is a perspective view of a tow bar swivel shown in FIG. 5;

FIG. 10 is a perspective view of a tow bar retainer shown in FIG. 5;

FIG. 11 is a bottom view of the front portion of the golf car of FIG. 1 with the wheels in a straight position;

FIG. 12 is a perspective view of the front portion of the golf car shown in FIG. 11 with the wheels in a rightmost turning position;

FIG. 13 is a side view of a rear tow assembly of a first golf car engaged with a front tow assembly of a second golf car; and

FIG. 14 is a perspective view of the front and rear tow assemblies.

### DETAILED DESCRIPTION

The following description is merely exemplary in nature and is in no way intended to limit the present disclosure, application, or uses. Throughout this specification, like reference numerals will be used to refer to like elements.

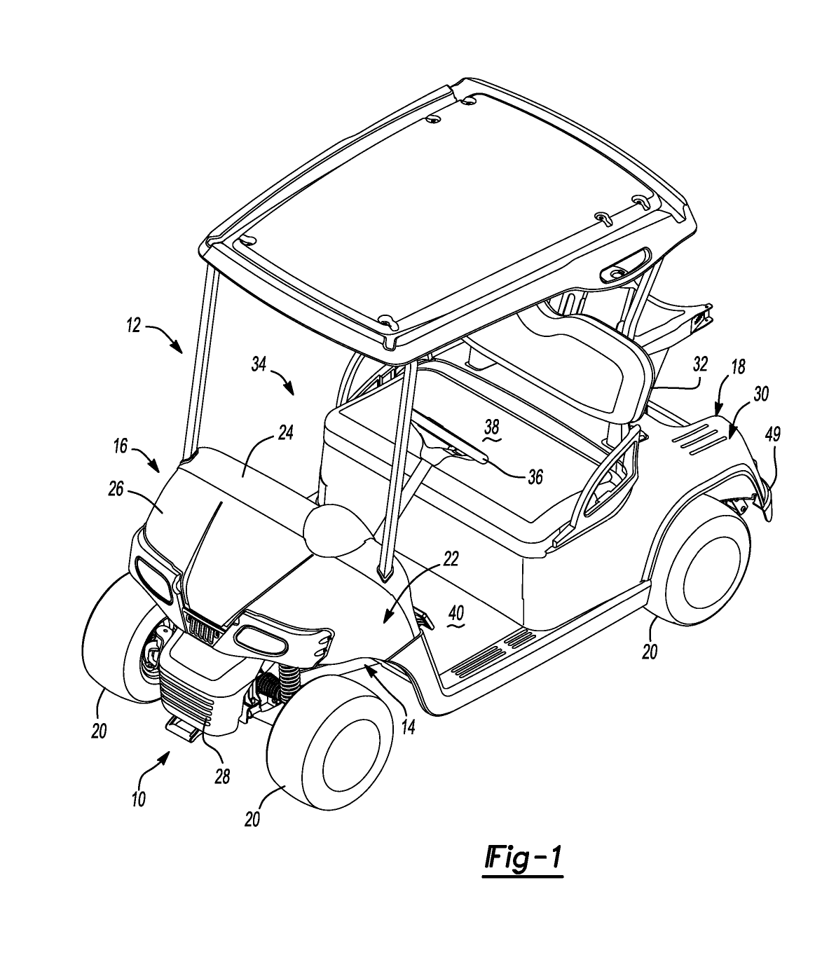

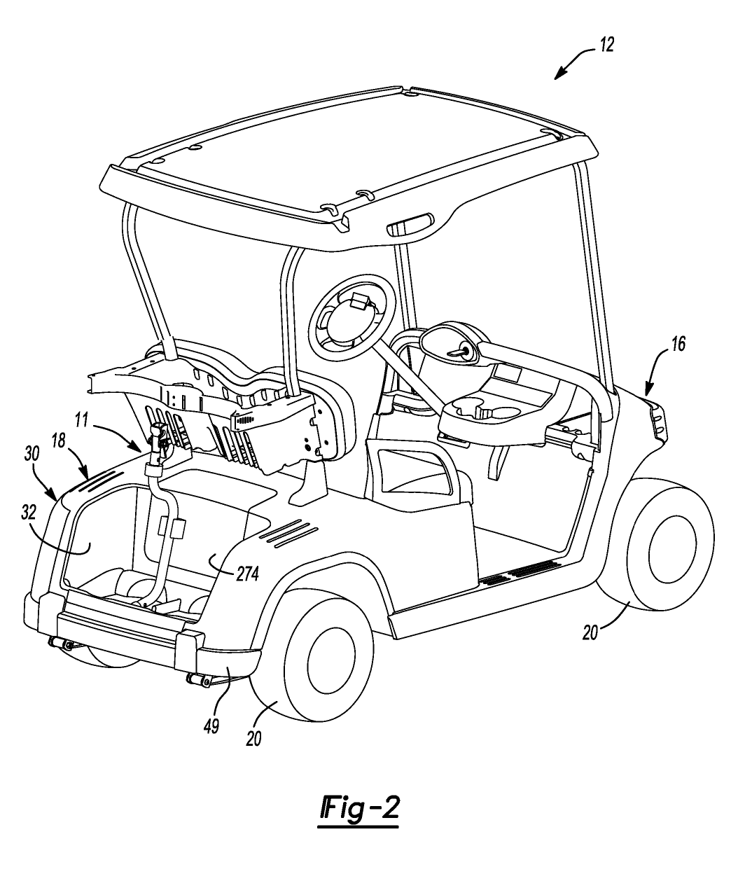

With initial reference to FIGS. 1 and 2, front and rear tow assemblies constructed in accordance to the present disclosure are shown and identified generally at reference numerals 10 and 11. The front and rear tow assemblies 10, 11 are illustrated operably connected to an exemplary golf car 12. It is appreciated that the golf car 12 is merely exemplary and that the front and rear tow assemblies 10, 11 can be adapted for use with other golf car configurations. Furthermore, the front and rear tow assemblies 10, 11 described herein are not limited for use with golf cars and can also be used with other vehicles such as, but not limited to, utility vehicles, lawnmowers, and other turf care vehicles.

The golf car 12 can include a frame 14 having a front portion 16 and a rear portion 18 mounted thereon. The golf car 12 can further include wheels 20 drivingly coupled to the frame 14.

The front portion 16 of golf car 12 can include a front body assembly 22 having an instrument panel 24, a front cowl 26, and a bumper 28. The front tow assembly 10 can be coupled to the frame 14 below the front portion 16 of the golf car 12. With additional reference to FIG. 3, the frame 14 can include a front end 50 having a vertically extending opening 52 therethrough. The opening 52 can be generally centered laterally between front wheels 20. The rear portion 18 can include a rear body assembly 30 having a golf bag storage area 32 and a passenger seating area 34. The passenger seating area 34 can include a steering wheel 36, accelerator and brake pedals (not shown), a seat 38, and a floor portion 40. The rear portion 18 can further include a rear bumper 49.

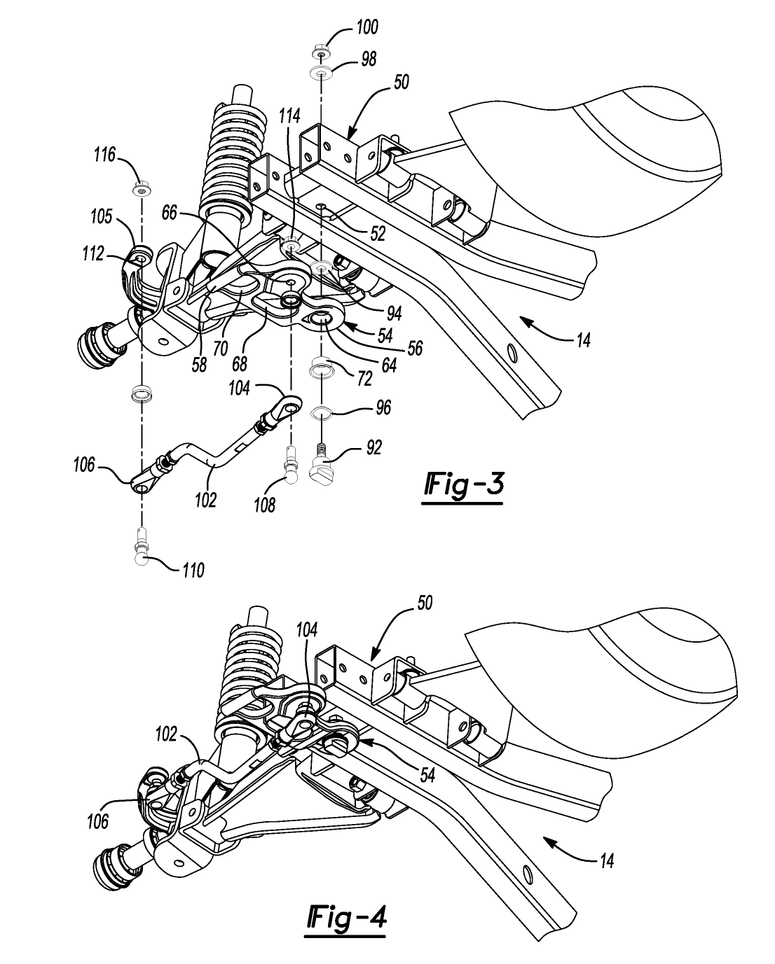

With particular reference to FIGS. 3, 4, and 14, front tow assembly 10 can include a body member 54 having first and second ends 56, 58 and upper and lower surfaces 60, 62, best shown in FIG. 14. The body member 54 can be integrally formed as a single stainless steel casting and include four apertures 64, 66, 68, 70, best shown in FIG. 3.

The first aperture 64 can be located in the first end 56. The first aperture 64 can generally be a generally circular bearing bore having a pressed in bushing 72 located therein, as shown in FIG. 3.

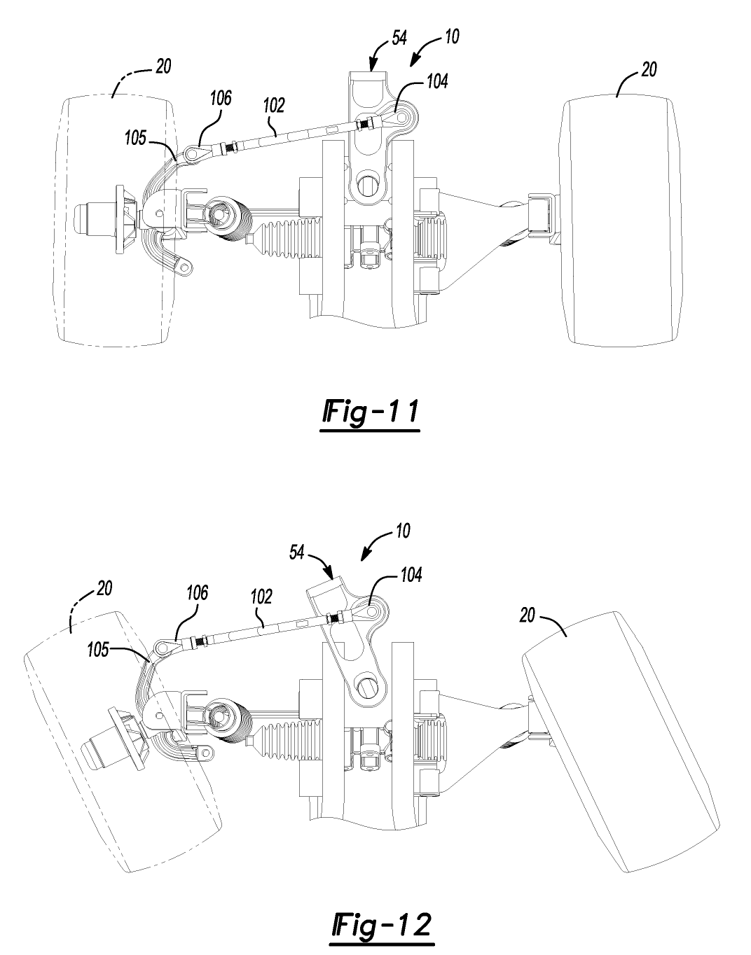

The second aperture 66 can be located between the first and second ends 56, 58 of body member 54. The second aperture 66 can be laterally offset from opening 52 in frame 14. More specifically, the second aperture 66 can be laterally offset in a direction toward the driver's side of golf car 12 when wheels 20 are in a straight position (seen in FIG. 11). The second aperture 66 can be generally circular and can be located in a recessed portion 74 of body member 54, as shown in FIG. 16. The recessed portion 74 can include a generally cylindrical outer wall 76. The outer wall 76 can have an opening 78 in communication with a channel 80. Channel 80 can be in communication with third aperture 68, thereby allowing water and debris to drain from recessed portion 74.

The third aperture 68 can be formed in a central portion of body member 54 generally between first and second ends 56, 58. The third aperture 68 can have an oval shape and can be in communication with recessed portion 74 via channel 80 as previously discussed. The third aperture 68 can also be generally laterally centered between first and second ends 56, 58, and can provide a weight reduction for body member 54 by reducing the amount of material used for the body member 54.

Fourth aperture 70 can be located in the second end 58 of body member 54. Fourth aperture 70 can be generally laterally aligned with frame opening 52 when wheels 20 are in a straight position (seen in FIG. 11). As shown in FIG. 14, an arcuate surface 82 can form a rear portion of fourth aperture 70 and a generally straight front surface 84 can form a front portion of fourth aperture 70. The generally straight front surface 84 can be located on an engagement portion 86 of body member 54. The fourth aperture 70 can receive a portion of rear tow assembly 11, as will be described herein.

Engagement portion 86 can be a generally rod-like member extending between sidewalls 88, 90 of fourth aperture 70. The engagement portion 86 can provide engagement between the front and rear tow assemblies 10, 11, discussed in greater detail below.

The first end 56 of body member 54 can be located generally beneath the front end 50 of frame 14. The opening 52 in frame 14 and first aperture 64 can be generally aligned with one another. A pivot bolt 92 can be placed through opening 52 and first aperture 64, coupling frame 14 to body member 54. A first flat washer 94 can be located on pivot bolt 92 generally between upper surface 60 of body member 54 and frame 14. A wavy washer 96 can be located on pivot bolt 92 and generally abut lower surface 62 of body member 54. A second flat washer 98 can be located on an end of pivot bolt 92. A nut 100 can be threaded onto an upward extending end of pivot bolt 92, capturing pivot bolt 92 in opening 52 and first aperture 64, and thereby pivotally coupling body member 54 to frame 14. Nut 100 can be a flanged nylon lock nut.

A steering link 102 can be coupled to second aperture 66 at a first end 104 and to a steering spindle casting 105 at a second end 106. The steering link 102 can have studs 108, 110 extending upward from ends 104, 106. Stud 108 can extend into second aperture 66 in body member 54, pivotally coupling body member 54 to steering link 102. Stud 110 can extend into an aperture 112 in steering spindle casting 105, pivotally coupling steering spindle casting 105 to steering link 102. Flanged nylon lock nuts 114, 116 can be coupled to studs 108, 110. Therefore, body member 54 and steering spindle casting 104 are coupled to each other through steering link 102, thereby allowing them to turn with one another. When turning, the off-center positioning of second aperture 66 can prevent steering link first end 104 from passing laterally centered opening 52 in a direction toward the passenger side of the golf car 12 to an over-center position. More specifically, the off-center positioning of second aperture 66 can prevent steering link first end 104 from passing laterally centered opening 52 when wheels 20 are turned to a rightmost extent (seen in FIG. 12).

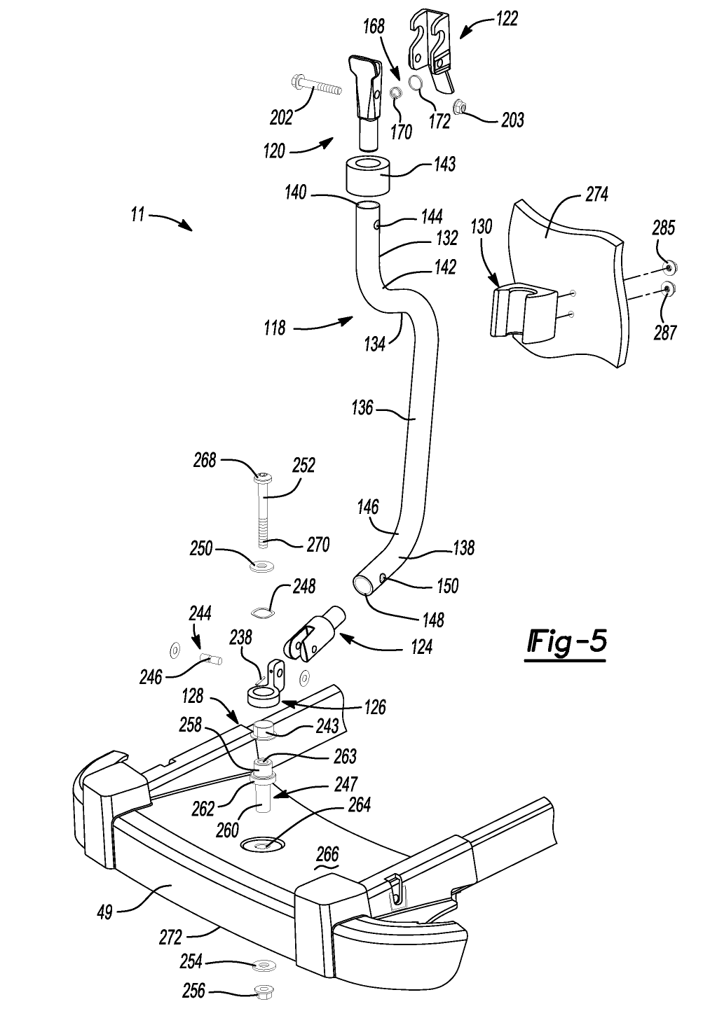

With additional reference to FIG. 5, the rear tow bar assembly 11 can include a tow bar 118, a tow bar latch base 120, a tow bar latch 122, a tow bar pivot 124, a tow bar swivel 126, a tow bar bumper attachment 128, and a tow bar retainer 130. The tow bar 118 can be a generally hollow tubular member having a generally circular cross-section. The tow bar 118 can include four sections 132, 134, 136, 138.

The first section 132 can include first and second ends 140, 142. A latch stop 143 can be located on the first section 132 generally between the first and second ends 140, 142. The latch stop 143 can have a generally annular ring-like configuration. First end 140 can be generally free and can provide access to the hollow center of tow bar 118. An aperture 144 can be located generally through first section 132 near first end 140. Second section 134 can extend from second end 142 of first section 132 at an angle. The angle can be between 0 and 90 degrees. Third section 136 can extend from second section 134 at an angle generally similar to the angle between the first and second sections 132, 134. As a result, third section 136 can be generally parallel to first section 132. Fourth section 138 can include first and second ends 146, 148. Fourth section 138 can extend from third section 136 at a first end 146. Second end 148 can be generally free and can provide access to the hollow center of tow bar 118. An aperture 150 can be located generally through fourth section 138 near second end 148.

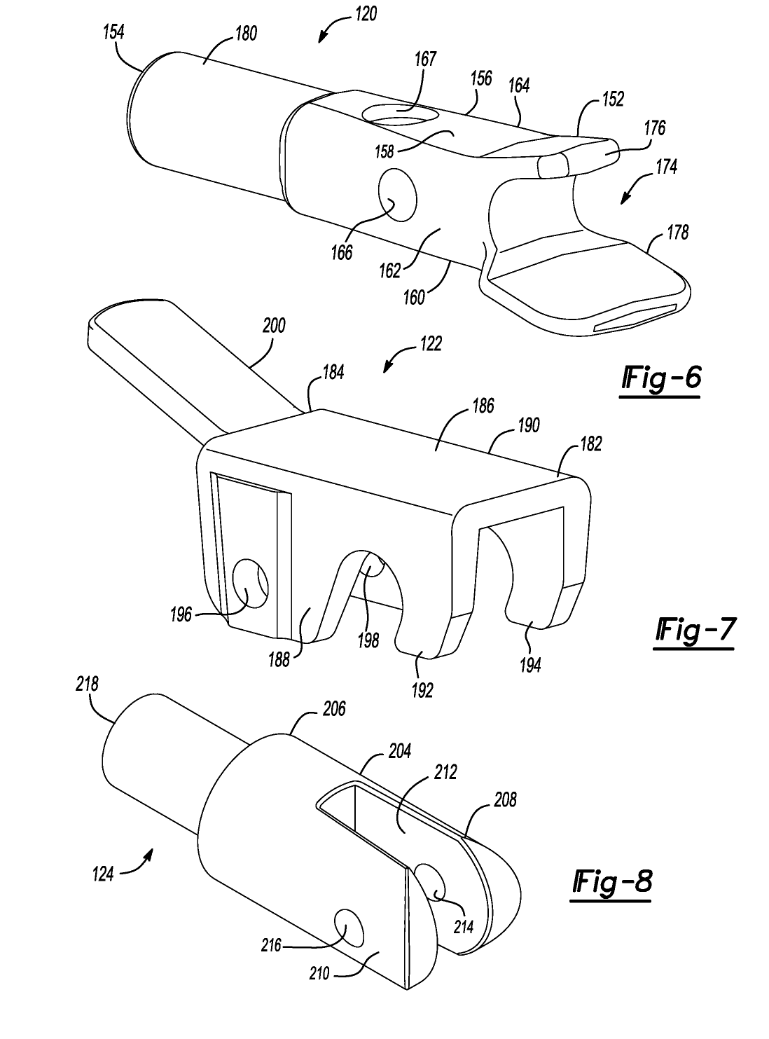

With additional reference to FIG. 6, tow bar latch base 120 can be formed as a unitary member from cast stainless steel. The tow bar latch base 120 can include first and second ends 152, 154. A central body portion 156 can be located between the first and second ends 152, 154. Central body portion 156 can have a generally rectangular cross-section providing upper, lower, and side surfaces 158, 160, 162, 164. A first aperture 166 can be formed in central body portion 156 and extend through side surfaces 162, 164. Upper surface 158 can include a countersink 167 for containing a biasing assembly 168. As shown in FIG. 5, the biasing assembly 168 can include a compression spring 170 and a cup washer 172.

The first end 152 can include a hitch receiving portion 174. The hitch receiving portion 174 can include an upper lip 176 and a latch stop 178. Upper lip 176 can extend from upper surface 158. Latch stop 178 can extend from lower surface 160 a distance beyond the extent of upper lip 176.

The second end 154 can include a weld boss 180 generally extending from central body portion 156. The weld boss 180 can be a generally cylindrical member having an outer diameter generally equal to or slightly less than the interior diameter of first section 132 of tow bar 118. The weld boss 180 can extend into first end 140 of tow bar 132 a distance past aperture 144. The tow bar latch base 120 can be welded to tow bar 118 at aperture 144.

With additional reference to FIG. 7, tow bar latch 122 can be formed as a unitary member from cast stainless steel. The tow bar latch 122 can include first and second ends 182, 184. The body of the tow bar latch 122 can have a generally U-shaped cross-section having an upper surface 186 and side surfaces 188, 190. Latch hooks 192, 194 can be formed in side surfaces 188, 190 at first end 182. Apertures 196, 198 can extend through side surfaces 188, 190 near second end 184. A latch lever arm 200 can extend at an angle from second end 184. The tow bar latch 122 can be rotatably coupled to tow bar latch base 120. Apertures 196, 198 can be generally aligned with aperture 166. A bolt 202 can be located within apertures 196, 198 and aperture 166. A nut 203 can be placed on an end of bolt 202, securing bolt 202 in place, rotatably coupling tow bar latch 122 to tow bar latch base 120. The biasing assembly 168 can bias tow bar latch 122 to an engaged position, discussed below.

With additional reference to FIG. 8, tow bar pivot 124 can be formed as a unitary member from cast stainless steel. Tow bar pivot 124 can include first and second ends 204, 206. Arms 208, 210 can extend from first end 204. Arms 208, 210 can be spaced apart from one another, forming a channel 212 therebetween. Apertures 214, 216 can generally extend through arms 208, 210. A weld boss 218 can extend from second end 206. The weld boss 218 can be a generally cylindrical member having an outer diameter generally equal to or slightly less than the interior diameter of fourth section 138 of tow bar 118. The weld boss 218 can extend into second end 148 of fourth section 138 a distance past aperture 150. Tow bar pivot 124 can be welded to tow bar 118 at aperture 150.

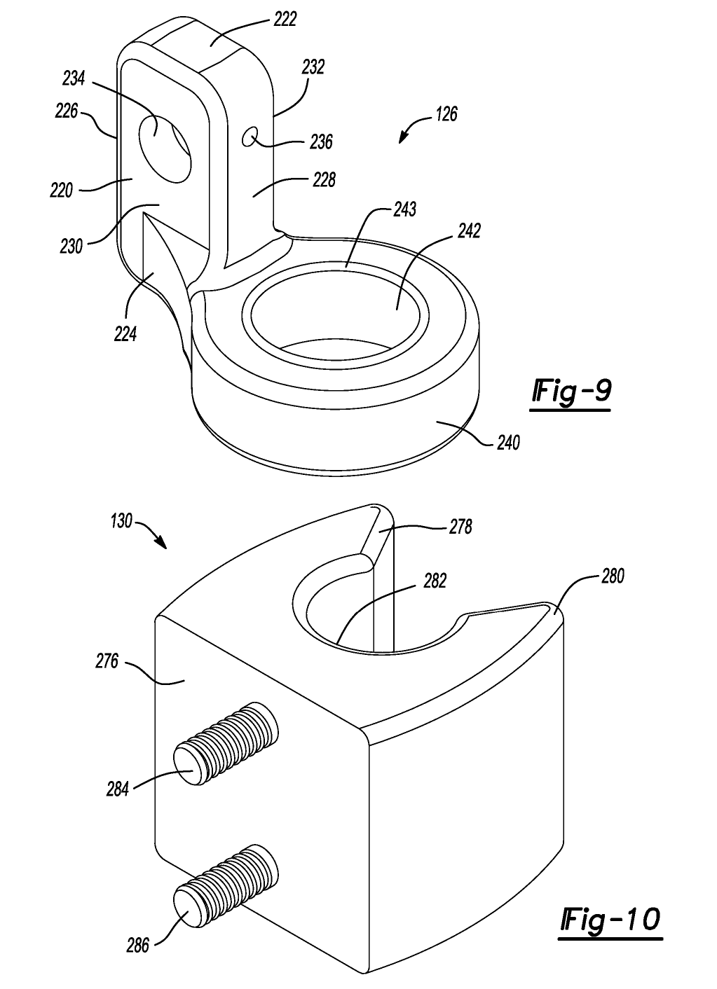

With additional reference to FIG. 9, tow bar swivel 126 can be formed as a unitary member from cast stainless steel. Tow bar swivel 126 can include a generally rectangular body member 220 having first and second ends 222, 224. The body member 220 can further include front, rear, and side surfaces 226, 228, 230, 232. An aperture 234 can extend through side surfaces 230, 232. An aperture 236 can extend through rear surface 228 and intersect an upper portion of aperture 234. A retention coil pin 238 can be located within aperture 236. An annular member 240 can extend from second end 224. The annular member 240 can include a generally circular open center portion forming a bearing bore 242. Bearing bore 242 can have a self-lubricating bushing 243 therein.

Rectangular body member 220 can be located between arms 208, 210 of tow bar pivot 124. Aperture 234 can be generally aligned with apertures 214, 216. A pivot pin 244 can extend through arms 208, 210 and aperture 234 in tow bar swivel 126. The pivot pin 244 can be retained by retention coil pin 238 engaging a groove 246 in pivot pin 244. The tow bar bumper attachment 128 can couple the tow bar swivel 126 to the golf car 12.

The tow bar bumper attachment 128 can include a tow bar pivot 247, a wavy washer 248, a first flat washer 250, a pan head bolt 252, a second flat washer 254, and a lock nut 256. The tow bar bumper attachment 128 can be coupled to the bumper 49 itself and does not require additional coupling to the frame 14. The tow bar pivot 247 can include an upper portion 258, a lower portion 260, and a flange 262 therebetween. The tow bar pivot 247 can have a generally hollow center portion 263. The lower portion 260 can have a length generally equal to the thickness of bumper 49. The lower portion can extend through an aperture 264 in bumper 49. Flange 262 can abut an upper surface 266 of bumper 49. Wavy washer 248 can be located on upper portion 258 of tow bar pivot 246 and abut flange 262. Tow bar swivel 126 can be placed on tow bar pivot upper portion 258 having bushing 243 generally surrounding upper portion 258. Bushing 243 can have a depth generally equal to the length of upper portion 258. Pan head bolt 252 can pass through center portion 263 of tow bar pivot 246. First flat washer 250 can be located on pan head bolt 252 between a bolt head 268 and bushing 243. Second flat washer 254 can be located on pan head bolt 252 between a threaded end 270 of the bolt 252 and a lower surface 272 of bumper 49. Lock nut 256 can be threaded onto threaded end 270, capturing pan head bolt 252 within tow bar pivot 247.

With additional reference to FIG. 10, tow bar retainer 130 can be coupled to a rear portion 274 of golf bag storage area 32. The tow bar retainer 130 can be formed as a unitary member from molded rubber. The tow bar retainer 130 can have a rear portion 276 with arms 278, 280 extending therefrom. The arms 278, 280 can have a generally arcuate C-shaped recess 282 therebetween. The C-shaped recess 282 can generally provide a snap-fit engagement with third portion 136 of tow bar 118 when tow bar 118 is in a retracted position. Threaded studs 284, 286 can generally extend from the rear portion 276 in a direction generally opposite arms 278, 280. Threaded studs 284, 286 can extend into rear portion 274 of golf bag storage area 32 and engage nuts (285, 287), coupling tow bar retainer 130 to golf car 12, as shown in FIG. 5.

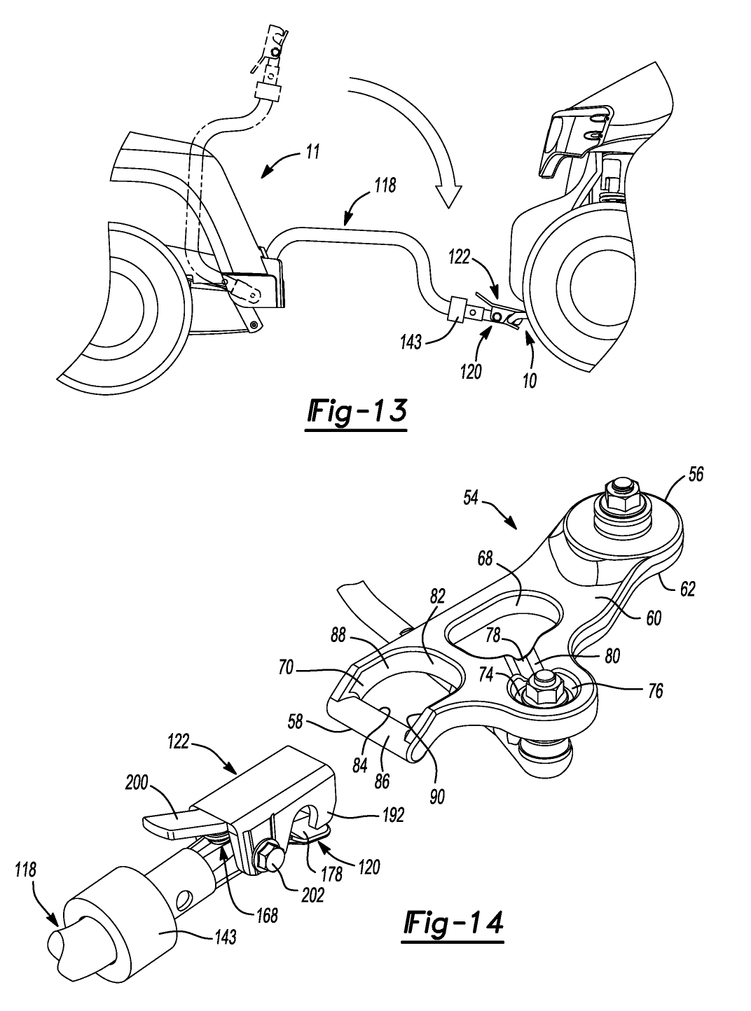

As seen in FIGS. 13 and 14, when in an extended position, rear tow assembly 11 of a first golf car can engage front tow assembly 10 of a second golf car. Latch lever arm 200 can be depressed, allowing engagement portion 86 of front tow assembly 10 to abut latch stop 178. Latch lever arm 200 can then be released and returned to engagement by biasing assembly 168. When engaged, engagement portion 86 of front tow assembly 10 can be captured between tow bar latch hooks 192, 194 and tow bar latch base latch stop 178.

The pivotal attachment of the body member 54 of front tow assembly 10 causes the body member 54 to move in the direction that the golf car is being towed. The attachment of the steering spindle casting 105 to the front tow assembly 10 causes the front wheels 20 to turn in the direction of the lead vehicle.

The description herein is merely exemplary in nature and, thus, variations that do not depart from the gist of that which is described are intended to be within the scope of the disclosure. Such variations are not to be regarded as a departure from the spirit and scope of the disclosure.

What is claimed is:

1. A tow assembly comprising:
a hitch member having first and second ends, said hitch member having a first mounting aperture at said first end and a second mounting aperture at said second end, said first and second mounting apertures generally aligned laterally with one another, said first mounting aperture configured to be rotatably coupled to a vehicle frame and said second mounting aperture having an engagement portion, said engagement portion configured to be selectively coupled to a towing member, said hitch member further including a third mounting aperture, said third mounting aperture laterally offset from said first and second mounting apertures and configured to be coupled to a steering link.

2. The tow assembly of claim 1, wherein said hitch member is formed as a unitary member.

3. The tow assembly of claim 2, wherein said hitch member is formed from cast stainless steel.

4. The tow assembly of claim 1, wherein said third mounting aperture is configured to be laterally offset toward a first side of a vehicle when said hitch member is coupled to said vehicle and a wheel coupled to said steering link is in a straight driving position.

5. The tow assembly of claim 4, wherein said first side is a driver's side of said vehicle.

6. The tow assembly of claim 4, wherein said lateral offset of said third mounting aperture is configured to prevent travel to a second side when a wheel coupled to said steering link is in an extreme turning position.

7. The tow assembly of claim 6, wherein said first side is a driver's side of a vehicle.

8. The tow assembly of claim 6, wherein said extreme turning position is a rightmost turning position.

9. The tow assembly of claim 1, further comprising a tow bar having a first end configured to be coupled to a vehicle and a second end configured to engage said engagement portion of said hitch member.

10. A vehicle comprising:
a frame;
a wheel assembly rotatably coupled to said frame;
a steering system including a steering link operably coupled to said wheel assembly; and
a hitch member having first and second ends, said hitch member having a first mounting aperture at said first end and a second mounting aperture at said second end, said first and second mounting apertures generally aligned laterally with one another, said first mounting aperture rotatably coupled to said vehicle frame, said second mounting aperture having an engagement portion configured to be selectively coupled to a towing member, said hitch member further including a third mounting aperture, said third mounting aperture laterally offset from said first and second mounting apertures and coupled to said steering link.

11. The vehicle of claim 10, wherein said hitch member is formed as a unitary member.

12. The vehicle of claim 11, wherein said hitch member is formed from cast stainless steel.

13. The vehicle of claim 10, wherein said vehicle is a golf car.

14. The vehicle of claim 10, wherein said wheel assembly is a front wheel assembly including two wheels, said hitch member generally centered between said two wheels.

15. The vehicle of claim 10, wherein said vehicle includes first and second sides, said third mounting aperture laterally offset toward said first side of said vehicle when said wheel assembly is in a straight driving position.

16. The vehicle of claim 15, wherein said first side is a driver's side of said vehicle.

17. The vehicle of claim 15, wherein said third mounting aperture is located on said first lateral side when said wheel assembly is in an extreme turning position.

18. The vehicle of claim 17, wherein said first side is a driver's side of said vehicle.

19. The vehicle of claim 17, wherein said extreme turning position is a rightmost turning position.

20. A golf car comprising:
a frame;
a front wheel assembly including two front wheels rotatably coupled to said frame;
a steering system including a steering link coupled to said wheel assembly; and
a hitch member having first and second ends, said hitch member having a first mounting aperture at said first end and a second mounting aperture at said second end, said first and second mounting apertures generally aligned laterally with one another, said first mounting aperture rotatably coupled to said golf car frame and said second mounting aperture having an engagement portion configured to be selectively coupled to a towing member, said hitch member further including a third mounting aperture, said third mounting aperture laterally offset from said first and second mounting apertures and coupled to said steering link, said third mounting aperture laterally offset toward a first side of said golf car when said wheel assembly is in a straight driving position and said third mounting aperture remaining on said first side of said golf car when said wheel assembly is in an extreme turning position.
